(19) United States
(12) Patent Application Publication
(10) Pub. No.: US 2006/0041873 A1
(43) Pub. Date: Feb. 23, 2006

(54) Computer system and method for verifying functional equivalence

(75) Inventors: Vinod Pandarinathan, Arumbakkam (IN); Richard B. Livingston, Miami, FL (US); VanniaRajan Chellappan, Kodambakkam (IN); James Lambert, Pleasanton, CA (US); Balachander Chandrasekaran, Milpitas, CA (US)

Correspondence Address: CARPENTER & KULAS, LLP, 1900 EMBARCADERO ROAD, SUITE 109, PALO ALTO, CA, 94303, US

(73) Assignee: Cisco Technology, Inc.

(21) Appl. No.: 10/922,076

(22) Filed: Aug. 19, 2004

(51) Int. Cl. G06F 9/45

(52) U.S. Cl. 717/141

(57) ABSTRACT

A computer system and method are provided for the verification of functional equivalence between at least two source codes residing on at least one computer. A comparison is carried out between a source code and a modified version of the source code. The comparison is performed to determine the functional equivalence between the two source codes. The functional equivalence is determined on the basis of type, scope and linkage of identifiers of the source codes. The identifiers are extracted from the assembly codes of the source codes.

### BACKGROUND OF THE INVENTION

1. Field of Invention

The present invention relates, in general, to the field of computer systems. More specifically, embodiments of the present invention relate to computer systems and methods for the verification and validation of functional equivalence between a system (e.g., a hardware or software system, such as a computer system or software code) and its modified version (i.e., a modified system).

2. Description of the Background Art

Computer programs, such as those written in C and C++, often undergo several development and improvement efforts. These development efforts involve the modification of a program to improve its functionality, reduction or elimination of redundant variables and/or functions. Some of these development activities involve addition or removal symbols and functions and redefinition of macros. These development activities may or may not lead to functional changes in the source code file and/or header files of a program. Development activities that do not bring about any functional change in the compiled source codes include, but are not limited to, removal of dead codes, restructuring header files, movement of functions from one file to another, and creating self-compilable header files.

Several comparison tools exist for comparing a source code and its versions to determine their differences. A comparison tool enables automation of source code modularity, dead code removal, and other aspects of source re-writing. Conventionally, comparison is performed by comparing the binary equivalents of the source code and its versions. One example of such a tool is ‘bdiff’, or binary file differencer, which is used on Unix. ‘bdiff’ is used to identify inequalities between two input files. However, the conventional techniques of comparison have several limitations. For example, if an unused string is removed from a source file, the address parameters of other entities also change. These changes produce large number of differences, which are incidental and do not necessarily imply a functional change. Thus, a large number of false positives are generated due to address and/or offset mismatch, which actually do not affect the functionality.

Moreover, sometimes modification of source codes results in unintentional macro changes. Macro changes result in run-time errors and not compile-time errors. Therefore, conventional tools may not be able to identify such macro changes. Additionally, binary comparison tools fail to compare the content of data bound by a symbol as there is no way to identify the extent of data bound by symbols especially in pointers. It is also difficult to identify and diagnose the mismatch detected by binary comparisons. This is because conventional tools generate a wide distribution of pointers, string constants and a large number of false positives that are ignored, as they do not result in functional differences. Moreover, a manual inspection of comparison log to identify the mismatch, especially in a large-development system, is cumbersome.

### SUMMARY OF EMBODIMENTS OF THE INVENTION

Embodiments of the present invention provide a computer system and a method for verifying functional equivalence. The method comprises providing a system, modifying the system to produce a modified system, and verifying if the modified system is a functional equivalence of the system.

These provisions, together with the various ancillary provisions and features which will become apparent to those artisans, possessing skill in the art, as the following description proceeds, are attained by devices, assemblies, systems and methods of embodiments of the present invention, various embodiments thereof being shown with reference to the accompanying drawings, by way of example only, wherein:

### BRIEF DESCRIPTION OF THE DRAWINGS

FIG. 1 is a schematic diagram illustrating an environment for the present invention, the environment being a computing system in accordance with various embodiments of the invention.

FIG. 2 is a flow chart illustrating a method for verifying functional equivalence in accordance with various embodiments of the invention.

FIG. 3 is a schematic overview of the working of various embodiments of the invention.

FIG. 4 is a flowchart that illustrates an exemplary flow of processes employed, in accordance with all the embodiments, to verify functional equivalence of a source code.

FIG. 5 is a block diagram illustrating the various elements of MatchMaker in accordance with various embodiments of the invention.

FIG. 6 is a flowchart illustrating an exemplary method for operating or running MatchMaker in accordance with the various embodiments.

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Also in the description herein for embodiments of the present invention, a portion of the disclosure recited in the specification contains material, which is subject to copyright protection. Computer program source code, object code, instructions, text or other functional information that is executable by a machine may be included in an appendix, tables, figures or in other forms. The copyright owner has no objection to the facsimile reproduction of the specification as filed in the Patent and Trademark Office. Otherwise all copyright rights are reserved.

A ‘computer’ for purposes of embodiments of the present invention may include any processor-containing device, such as a mainframe computer, personal computer, laptop, notebook, microcomputer, server, personal data manager or ‘PIM’ (also referred to as a personal information manager), smart cellular or other phone, so-called smart card, set-top box, or any of the like. A ‘computer program’ may include any suitable locally or remotely executable program or sequence of coded instructions which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio or graphical images. If a computer is employed for synchronously presenting multiple video program ID streams, such as on a display screen of the computer, the computer would have suitable instructions (e.g., source code) for allowing a user to synchronously display multiple video program ID streams in accordance with the embodiments of the present invention. Similarly, if a computer is employed for presenting other media via a suitable directly or indirectly coupled input/output (I/O) device, the computer would have suitable instructions for allowing a user to input or output (e.g., present) program code and/or data information respectively in accordance with the embodiments of the present invention.

A ‘computer readable medium’ for purposes of embodiments of the present invention may be any medium that can contain, store, communicate, propagate, or transport the computer program for use by or in connection with the instruction execution system apparatus, system or device. The computer readable medium can be, by way of example only but not by limitation, an electronic, magnetic, optical, electromagnetic, infrared, or semiconductor system, apparatus, system, device, propagation medium, or computer memory. The computer readable medium may have suitable instructions for synchronously presenting multiple video program ID streams, such as on a display screen, or for providing for input or presenting in accordance with various embodiments of the present invention.

“Functional equivalence” means that a given input into a system (e.g., a software system, a computer system, a mathematical function, etc.) will produce or yield from the system an output which is the same output produced from a modified system (i.e., the system after having been modified) when employing or receiving the same given input. Stated alternatively, “functional equivalence” between a system and a modified system exists if a given input into the modified system will produce the same output that is produced by the system when employing or receiving the same given input. A system may be any suitable system, such as a software system (e.g., source code), a hardware system (e.g., a computer system), a mathematical function, or any of the like. A modification may be any suitable modification, such as by changing software instructions, removing files, hardware modification, changes to mathematical function, etc. By way of example only, a functional equivalence for a modification to a hardware system exists if an input to the hardware system and the same input to the modified hardware system produce the same output for the hardware system and the modified hardware system. By further way of example only, a functional equivalence for a modification to a software system exists if an input to the software system and the same input to the modified software system produce the same output for the software system and the modified software system. Thus, for various embodiments of the present invention, a modified version of a source code is said to be functionally equivalent to the original source code if the original source code and the modified source code perform functions identically and produce the same output. More particularly, two codes are functionally equivalent if there is no change in the instructions or content of the data objects in the source code and the modified source code. However, there may be differences in the location of the instructions and data objects. While embodiments of the present invention will be described hereafter with the system comprising a source code, it is to be understood that the spirit and scope of the present invention may include any suitable software system or hardware system.

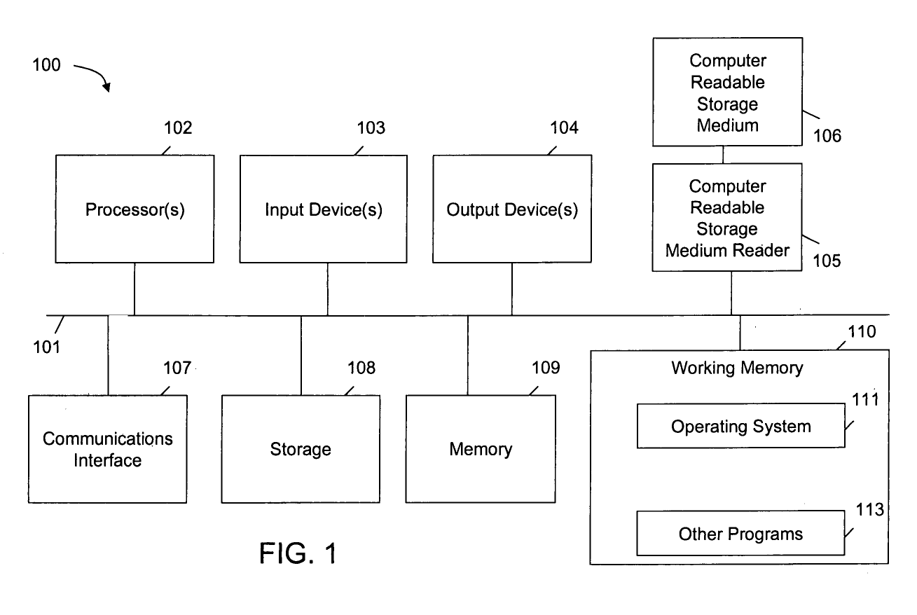

Referring now to FIG. 1, there is seen an exemplary computing system that can conduct or operate one or more procedures in accordance with various embodiments of the present invention. While other alternatives might be utilized, it will be presumed for clarity sake that components of the system(s) of FIG. 1 and elsewhere herein are implemented in hardware, software or some combination by one or more computing systems consistent therewith, unless otherwise indicated.

Computing system 100 comprises components, coupled via one or more communication channels (e.g., bus 101), including one or more general or special purpose processors 102, such as a Pentium®, Centrino®, Power PC®, digital signal processor (“DSP”), and so on. System 100 also includes one or more input devices 103 (such as a mouse, keyboard, microphone, pen, and so on), and one or more output devices 104, such as a suitable display, speakers, actuators, and so on, in accordance with a particular application.

Computing System 100 also includes a computer readable storage medium reader 105 coupled to a computer readable storage medium 106, such as a storage/memory device or hard or removable storage/memory media. Such devices or media may be further indicated separately as a storage 108 and a memory 109, which may include hard disk variants, floppy/compact disk variants, digital versatile disk (‘DVD’) variants, smart cards, partially or fully hardened removable media, read-only memory, random access memory, cache memory, and so on, in accordance with the requirements of a particular application. One or more suitable communication interfaces 107 can also be included, such as a modem, DSL, infrared, RF or other suitable transceiver, and so on, for providing inter-device communication directly or via one or more suitable private or public networks or other components that can include but are not limited to those already discussed.

Computing system 100 further includes a working memory 110 that includes an operating system (OS) 111, and one or more other programs 113. Working memory components can also include one or more of application programs, mobile code, and data, and so on, for implementing system elements that might be stored or loaded therein during use.

OS 111 can vary in accordance with a particular device, features or other aspects in accordance with a particular application (e.g. Windows, WindowsCE, Mac, Linux, Unix or Palm OS variants, a cell phone OS, a proprietary OS, and so on). Various programming languages or other tools can also be utilized, such as those compatible with C variants (e.g., C++, C#), the Java 2 Platform, Enterprise Edition (“J2EE”), or other programming languages in accordance with the requirements of a particular application. Such working memory components can, for example, include one or more of applications, add-ons, applets, custom software, and so on for conducting, but not limited to, the examples discussed elsewhere herein. Other programs 113 can, for example, include one or more of the aforementioned security, compression, synchronization, backup systems, Web browsers, conferencing programs, education programs, groupware code, and so on, including but not limited to those discussed elsewhere herein.

For the purpose of the embodiments of the present invention, input, intermediate or resulting data or functional elements can further reside transitionally or persistently in a storage media, cache or other volatile or non-volatile memory, (e.g., storage device 108 or memory 109) in accordance with a particular application.

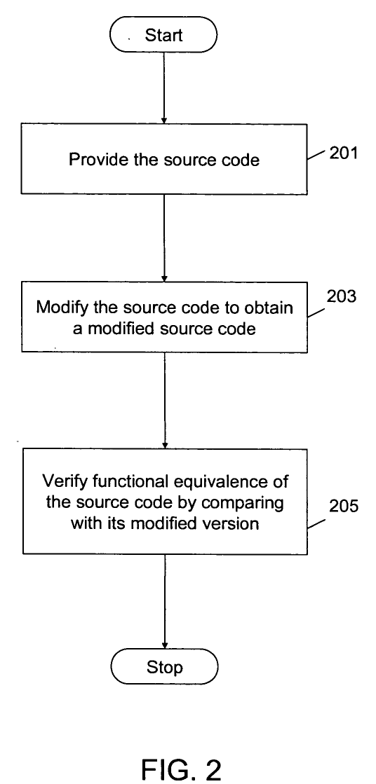

Embodiments of the present invention include a tool (e.g., tool, such as MatchMaker, identified below as “327”) residing in computing system 100, more particularly in working memory 110 of the computing system 100, for verifying the functional equivalence between a source code and a modified version of the source code. Referring to FIG. 2, a method for verifying functional equivalence in accordance with various embodiments of the invention is illustrated. At step 201, a source code is provided to a computer system that is equipped with the tool of embodiments of the present invention. At step 203, a user modifies the source code to obtain a modified source code. The user could be a software developer or any other person. The source code could be modified by the user for the purpose of improving the code by removing unused or dead codes, restructuring header files within the source code, moving functions from one file to another within the source code, or creating self-compilable header files. However, the techniques of introducing improvements in the source code should not be considered limited to these alone. Other forms of improvements can also be considered. Many times, such improvement activities cause the functionality of the source code to change. The functional equivalence between the source code and the modified source code is determined at step 205. The verification is based on a comparison of the type, scope, and linkage of identifiers of the source code and the modified source code.

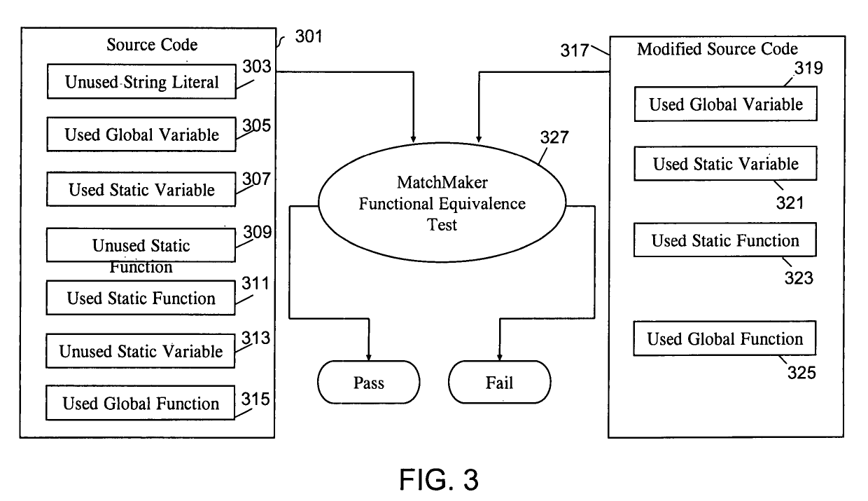

FIG. 3 provides a schematic overview of the working of various embodiments of the invention. A source code 301 comprises various elements that form the code. The elements include, but are not limited to, an unused string literal 303, a used global variable 305, a used static variable 307, an unused static function 309, a used static function 311, an unused static variable 313, and a used global function 315. Source code 301 can be re-organized to obtain a modified source code 317.

As previously explained, for various embodiments of the present invention modified source code 317 is obtained when source code 301 is updated or re-structured or some changes are introduced in it so as to improve the functionality of source code 301. For example, elements of source code 301 that are not used can be removed to obtain modified source code 317. Elements of source code 301 that are not used include unused string literal 303, unused static function 309, unused static variable 313, and unused global function 315. It is possible that more than one of each of the above mentioned unused elements are present in source code 301.

Subsequent to the removal of the unused elements, modified source code 317 is left with used global variable 319, used static variable 321, used static function 323, and used global function 325. It is possible that more than one of each of these elements is present in modified source code 317. It is also possible that some of these elements, namely used global variable 319, used static variable 321, used static function 323, and used global function 325, are modified forms of their corresponding used global variable 305, used static variable 307, used static function 311, and used global function 315 in source code 301.

The functional equivalence between source file 301 and modified source file 317 is verified by a tool 327, hereinafter referred to as MatchMaker. MatchMaker 327 performs a test for functional equivalence between source code 301 and modified source code 317. For the purpose of performing the test for functional equivalence, MatchMaker 327 takes inputs from source code 301 and modified source code 317. In an embodiment, the inputs are in the form of assembly codes of the respective source codes. MatchMaker 327 compares the assembly codes of source code 301 and modified source code 317. MatchMaker 327 generates the results of the comparison in the form of a display indicating a ‘Pass’ or a ‘Fail’. ‘Pass’ implies that the two codes are functionally equivalent, while ‘Fail’ implies that the two codes are not functionally equivalent. In the process of verifying the equivalence, MatchMaker 327 can also locate the cause for the functional inequality.

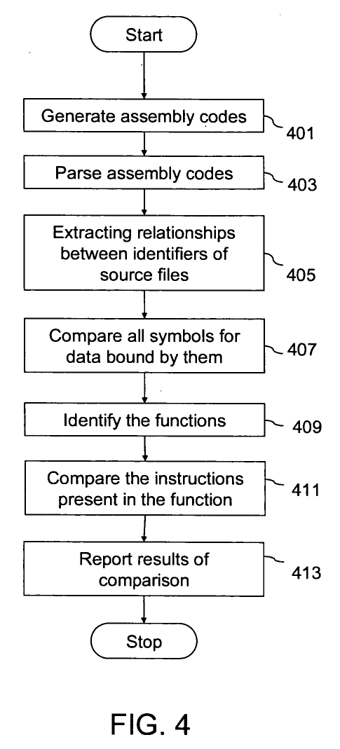

FIG. 4 illustrates an exemplary flow of processes employed by MatchMaker 327, in accordance with embodiments of the present invention, to verify functional equivalence between source codes. For illustrating, by way of example only, the exemplary flow of processes in FIG. 4, the source codes being verified may be assumed to be source code 301 and modified source code 317. According to step 401, the assembly codes for source file 301 and modified source file 317 are generated. The assembly codes are generated by first identifying the assembly code structure specific to the machine on which source code 301 and modified source code 317 are executed. The assembly code structure is used as a template to generate the assembly codes corresponding to source code 301 and modified source code 317. At step 403, MatchMaker 327 parses the assembly codes to identify and obtain the identifiers such as the global symbols and static variables and functions, labels, and location counters. Subsequently, at step 405 the relationships between the corresponding identifiers of the source files are extracted. Following step 405, MatchMaker 327 compares the assembly codes on the basis of the extracted relationships. This comprises comparison of all the global symbols for the data bound by them at step 407. Subsequently, all the functions present in the assembly codes are identified at step 409. At step 411, MatchMaker 327 compares the instructions present in the identified functions.

At step 411, the instructions are compared in the form of mnemonics. As previously mentioned, a logical comparison is carried out on the basis of the type, scope, and linkage of an identifier. This comparison is performed on the basis of the extracted relationships between various entities such as the variables and functions, their type, scope, and linkage that are obtained from the assembly codes. If all the corresponding global symbols and static/requisite functions in the assembly codes are generally identical, source code 301 and modified source code 317 are said to be functionally equivalent. The comparison between the assembly codes is performed on the basis of two sets of rules, which determine the functional equivalence between source code 301 and modified source code 317. The two sets of rules will be explained hereafter. Following the comparison, at step 413, the results of the comparison are reported in the form of a display indicating ‘Pass’ or ‘Fail’.

The time complexity of the process of comparison is of the order of (n+s), wherein ‘n’ is the code size and ‘s’ is the number of global symbols. Global symbols are compared for the data bound by them though they have no reference from the text region of this assembly file. By default they are assumed to be exported to other modules. However local symbols and static symbols are compared as part of the instruction [immediate operands] comparison [i.e only if they are used in any of the instruction]. Thus, the time complexity increases with increase in the size of the code. This is implied from the fact that if the size of a code is large, then the corresponding modified version is also large.

The verification for functional equivalence is governed by two sets of rules. The first set offers rules that do not affect the functional equality between the source codes. According to these rules, the changes in offset due to the removal of string literals do not result in functional inequality. This is because such changes in offset are caused due to the elimination of unused static symbols and they do not introduce functional changes. Similarly, a change in address operands, changes due to preprocessor directives such as _LINE_, and changes brought about by removal of unused static symbols and/or unused static functions, and the like, do not affect the functionality of source code 301. In this case, MatchMaker 327 returns the result of the comparison as ‘Pass’.

The second set offers rules that affect the functional equivalence between the two source codes being compared. Functional inequalities exist between source code 301 and modified source code 317 if at least one of these rules is satisfied. According to these rules, removal of any global symbol, requisite static symbol, requisite static function, macro redefinitions, changes in data section that includes the data bound by a symbol, or changes in the text section imply a change in functionality. The above-mentioned rules are with respect to changes made in source code 301 to obtain modified source code 317.

In an alternate embodiment of the invention, MatchMaker 327 performs a comparison of the source codes residing in different machine types. Different machine types, such as 68K processor, MIPS processor, PPC processor, and the like, may have different assembly code structures. MatchMaker 327 supports various types of machines to compare their assembly codes. In accordance with another embodiment of the invention, MatchMaker 327 allows generation of multiple comparison reports. Multiple reports may be generated with any suitable switches, which may be different switches. Source files of particular machine type are compared using the appropriate variant of MatchMaker. The switch would specify the format of the report generated by MatchMaker namely short mode, verbose mode and error mode. Short mode the output specifies whether the files compared pass equivalence test. In the error mode MatchMaker emits the function inequivalences encountered on the file comparison and verbose mode outputs the functions/global symbols compared and the functional inequivalences.

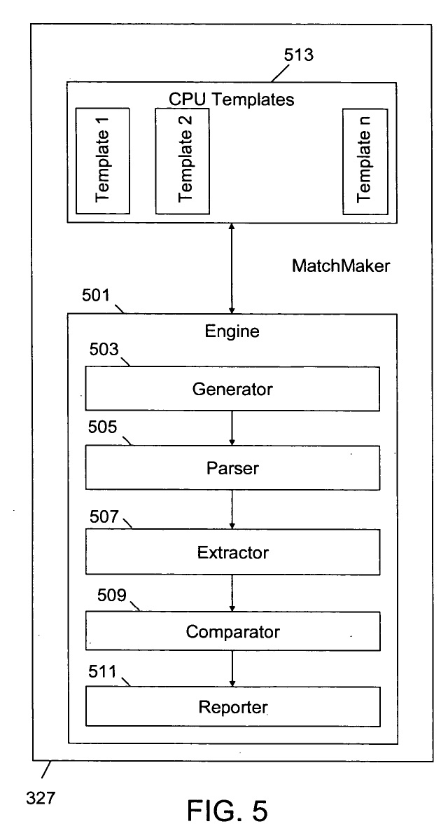

FIG. 5 is a block diagram illustrating the various elements of MatchMaker 327 in accordance with various embodiments of the invention. MatchMaker 327 comprises two modules, namely an engine 501 and CPU templates 513. MatchMaker 327 performs the process of comparison of source code 301 and modified source code 317 in engine 501. Engine 501 implements the algorithm used to compare two assembly programs and reports their matches. Engine 501 comprises a generator 503, a parser 505, an extractor 507, a comparator 509, and a reporter 511.

Generator 503 generates assembly codes corresponding to source code 301 and modified source code 317. The assembly code for any source code can be obtained by specifying an appropriate command line option to a compiler. For C and C++ parser 505 parses the assembly codes to identify and obtain identifiers such as the global symbols and static variables and functions, labels, and location counters. The identifiers are stored in a hash table and are provided to extractor 507 which extracts the relationships between the various identifiers present in the assembly codes. Following the extraction of the relationships, comparator 509 compares the assembly codes corresponding to source code 301 and modified source code 317. Finally, reporter 511 generates the report comprising the results of the comparison.

The working of engine 501 is dependent on instruction sets and addressing modes being used in the source codes. The comparison is done based on the addressing mode. The operands of the instruction using immediate addressing the operands are compared directly. Instructions using offset based addressing are compared by comparing the data bound by the offsets and not the offset themselves. Instructions using register addressing are compared by comparing the appropriate operands [registers] directly. The instruction set comprises the instruction and its associated operands. Instructions are in the form of an opcode. The instruction set normally follows the format <mnemonic><op1><op2><op3>, wherein <mnemonic> is the opcode for the instruction and <op1>, <op2>, and <op3> are the operands on which the instruction operates. The operands are in the form of data, which can be integers, decimals, or any other; or symbols that may point to or contain some form of data. During the comparison, the instructions in both the source files are matched first. A functional change is implied if the instructions differ. If the instructions match, the operands associated with the matched instruction in both the source files are compared. The operand comparisons include but are not limited to comparisons of locations counters, symbols, and immediate operands.

It is to be noted that two assembly codes, corresponding to the source code and its modified version, can be functionally identical even though the location counters are different. This difference can be attributed to removal of the unused static symbols. In the process of comparison, MatchMaker 327 identifies and compares the data bound by these locations counters. The location counters may be deduced to be functionally identical or equivalent if the data bound by these location counters are the same. Similarly, the data symbols are preferably identical and the data bound by these symbols are also preferably matched for their functional equivalence. Additionally, corresponding immediate operands are preferably identical for functional equivalence.

The other module within MatchMaker 327, CPU templates 513, provides engine 501 with the necessary information to perform comparison. The necessary information is in the form of assembly code structures corresponding to one or more machines in which the source codes reside. CPU templates 513 specify the machine type and any particulars (e.g., such as syntax of the location counters, registers, symbols, functions) related to the assembly code structure for that machine. There are various templates in CPU templates 513 that provide assembly code structures corresponding to a machine type. The engine picks up an appropriate CPU template from CPU templates 513 based on the assembly codes given to it for comparison. Engine 501 reads this template and compares the given assembly code on the basis of the template provided by CPU templates 513. CPU templates 513 enable comparator 509 to work on assembly listings for different family of processors without actually changing the engine. Thus, only one engine may be required for all types of machines instead of having an engine specific to each machine type.

In an embodiment, each of the elements of MatchMaker 327 is implemented in the form of one or more program instructions implemented in a computer readable medium. In an embodiment, MatchMaker 327 is installed in a computer readable medium after installing the Practical Extraction and Reporting Language Version 5.0 (PERL 5.0). PERL 5.0 is a programming language that can read and write binary files and can process very large files. However, for purposes of the embodiments of the invention, the language used is not limited to PERL 5.0. Other languages or versions of PERL 5.0 can be used. Following the installation of PERL 5.0, MatchMaker 327 is copied into <verification> directory. The verification directory can be placed anywhere based on the needs of the user. In an embodiment, MatchMaker 327 can run on Sun SPARC running SunOS 2.6 or Linux, with a physical memory space of at least 64 megabytes random access memory (RAM), and a secondary storage space of 10 megabytes. However, the invention, in accordance with all its embodiments, are not to be considered limited to these specifications. MatchMaker 327 can also operate on other platforms and computers with different memory sizes and storage spaces.

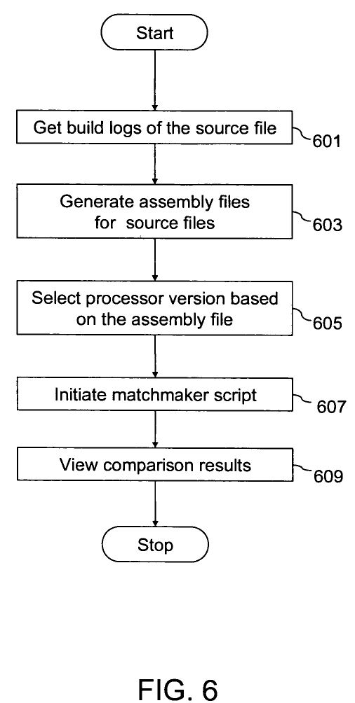

FIG. 6 illustrates an exemplary method for operating or running MatchMaker 327 in accordance with the various embodiments. Users such as software developers or program developers operate MatchMaker 327. At step 601, the user gets the build logs of source code 301. A build log is a report that maintains the sequence in which the files containing the source code are compiled and linked. As a result, a binary executable image is created. Build logs are used to build/generate the assembly files, executables and binary image. Source code 301 can have more than one build log when it is used in multi-variant builds. At step 603, the user generates the assembly codes for source code 301 and modified source code 317. If the source code is written in the C programming language, assembly codes for the source codes can be generated using the ‘-S’ option of the GNU gcc compiler. The ‘-S’ option instructs the compiler to stop after compilation of the source code to assembly code and produce a text file (preferably with a*.s extension), which contains the textual representation of the assembly mnemonics generated by the compiler. At step 605, the user selects the processor version of MatchMaker 327 based on the assembly code that is generated. This step is carried out with the help of engine 501 and CPU templates 513 described previously. The user initiates MatchMaker 327 at step 607. MatchMaker 327 can be initiated with the following command line:
MatchMaker.mips−s−o<Reference File><Modified File>
where: Reference File is the name of source code 301, and Modified File is the name of modified source code 317.

At step 609, the user views the results of the comparison.

Various embodiments of the present invention offer various options for the purpose of reporting the comparison results by using reporter 511. For instance, in an embodiment, the output options provided by MatchMaker 327 include a ‘v’ Verbose mode, a ‘e’ Error mode and a ‘s’ Short mode. In the ‘v’ Verbose mode, MatchMaker 327 prints the comparison results for all the functions in the source code that were checked for functional equivalence. In the ‘e’ Error mode, the user views the comparison results in the form of all the functions that failed the comparison. This option lists out all the functions, which are not functionally equivalent. In the ‘s’ Short mode, MatchMaker 327 displays the comparison result of an individual file within the source code. The user can specify the switch and/or file, based on the desired granularity of the comparison results.

Other options offered to the user are in the form of file options. In such cases, the user can specify the type of files that are being compared, and view the comparison results in a manner appropriate for the type of file selected by the user. One file option is for ‘Firmware Files’. In this option, files that are used especially to program hardware devices such as FPGA and DSP are used. Another option provided is for ‘Other Files’. These include files that are of the form other than firmware files.

Embodiments of the present invention are further explained by the following examples by way of illustration only, and not by way of any limitation. The following examples are not to be construed to unduly limit the scope of the invention. It is to be noted that in the examples provided hereinafter, the symbol “//” before an array means that the array was removed in order to modify the software system.

### EXAMPLE 1

1. C Source file to illustrate mismatch in global symbols due to
macro redefinition.

a. C File Before Scrub
#include
#include“macro_definition.h”
#ifdef SCRUB
#define VALUE 10000
#else
#define VALUE 1
#endif
int somevalue=VALUE;
int main( ){
return 1;
}
b. c File After Scrub
#include
//#include“macro_definition.h”
#ifdef SCRUB
#define VALUE 10000
#else
#define VALUE 1
#endif
int somevalue=VALUE;
int main( ){
return 1;
}
c. Contents of macro_definition.h
#define SCRUB
d. Comparison Results
Comparing file a.s.ref.68
In Funct 0: Mismatch in _somevalue
In Funct 0: Mismatch in _somevalue,_somevalue
:: .long 10000
:: .long 1
In Funct 0: Mismatch in _somevalue
In Funct 0: Mismatch in _somevalue,_somevalue
:: .long 10000
:: .long 1
Checking Function _main ...
File a.s.ref.68.... [FAIL]

### EXAMPLE 2

1. Assembly code listing showing the difference in object code due to unused strings removal.

| a. C File Before Scrub | |
|---|---|
| #include<stdio.h> | |
| #include“a.h” | |
| char *p=“ String literal”; | |
| int main ( ) | |
| { | |
| printf (“Hello world %s\n”,p); | |
| return 1;} | |
| b. C File After Scrub | |
| #include<stdio.h> | |
| //#include“a.h” | |
| char *p=“ String literal”; | |
| int main ( ) | |
| { | |
| printf (“Hello world %s\n”,p); | |
| return 1;} | |
| c. Contents of Header file “a.h” | |
| static inline function(int a, int b) | |
| { | |
| printf(“This is a missing string literal %d %d ”, a, b); | |
| return 1; | |
| } | |
| d. Assembly code listing of Reference file (before scrub) | |
| .file | 1 “a.c” |
| gcc2_compiled.: | |
| _gnu_compiled_c: | |
| .rdata | |
| .align | 3 |
| $LC0: | |
| .ascii | “This is a missing string literal %d %d \000” |
| .globl | p |
| .align | 3 |
| $LC1: | |
| .ascii | “ String literal\000” |
| .sdata | |
| .align | 2 |
| .type | p,@object |
| .size | p,4 |
| p: | |
| .word | $LC1 |
| .rdata | |
| .align | 3 |
| $LC2: | |
| .ascii | “Hello world %s\n\000” |
| .text | |
| .align | 2 |
| .globl | main |
| .ent | main |
| main: | |
| .frame | $fp,48,$31 # vars= 0, regs= 2/0, |
| args= 32, extra= 0 | |
| .mask | 0xc0000000,−8 |
| .fmask | 0x00000000,0 |
| subu | $sp,$sp,48 |
| sd | $31,40($sp) |
| sd | $fp,32($sp) |
| move | $fp,$sp |
| jal | _main |
| la | $4,$LC2 |
| lw | $5,p |
| jal | printf |
| li | $2,1 # 0x1 |
| j | $L3 |
| $L3: | |
| move | $sp,$fp |
| ld | $31,40($sp) |
| ld | $fp,32($sp) |
| addu | $sp,$sp,48 |
| j | $31 |
| .end | main |
| e. Assembly code listing of modified file (after scrub) | |
| .file | 1 “a.c” |
| gcc2_compiled.: | |
| _gnu_compiled_c: | |
| .globl | p |
| .rdata | |
| .align | 3 |
| $LC0: | |
| .ascii | “ String literal\000” |
| .sdata | |
| .align | 2 |
| .type | p,@object |
| .size | p,4 |
| p: | |
| .word | $LC0 |
| .rdata | |
| .align | 3 |
| $LC1: | |
| .ascii | “Hello world %s\n\000” |
| .text | |
| .align | 2 |
| .globl | main |
| .ent | main |
| main: | |
| .frame | $fp,48,$31 # vars= 0, regs= 2/0, |
| args= 32, extra= 0 | |
| .mask | 0xc0000000,−8 |
| .fmask | 0x00000000,0 |
| subu | $sp,$sp,48 |
| sd | $31,40($sp) |
| sd | $fp,32($sp) |
| move | $fp,$sp |
| jal | _main |
| la | $4,$LC1 |
| lw | $5,p |
| jal | printf |
| li | $2,1 # 0x1 |
| j | $L2 |
| $L2: | |
| move | $sp,$fp |
| ld | $31,40($sp) |
| ld | $fp,32($sp) |
| addu | $sp,$sp,48 |
| j | $31 |
| .end | main |

f. Comparison Results
Comparing file a.s.ref
Checking Function main...
File a.s.... [PASS]

The assembly code listings above illustrate the differences in the source code due to the removal of unused strings. Removal of unused strings lead to the change in offsets or location counters, this result in different object codes. Though the source code differs, the files are functionally equivalent.

### CONCLUSION

As shown by using examples 1 and 2, MatchMaker 327 can pinpoint the impact of functional changes at the symbol level. This is indicated from the fact that the basis on which functional equivalence is determined includes data contained by symbols. Thus, MatchMaker 327 can be used to study and identify how the functionality of a code is changed due to new feature additions. The study helps in ensuring the functional identity of the source code except for the new functions and variables introduced by the feature and thus prevent code degeneration due to new feature additions.

MatchMaker 327 presented by various embodiments of the present invention may be used to verify large software systems having multi-variant builds. The simplicity and ease with which MatchMaker 327 can be installed and the comparison results viewed, eliminates the cost incurred on unit/regression tests to verify the functionality. At the same time, MatchMaker 327 provides complete verification of source code coverage unlike regression/unit tests. Furthermore, MatchMaker 327, as described herein, can be integrated and invoked from a build system. The ability to integrate automates the verification process for determining functional equivalence.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general-purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for verifying functional equivalence of source codes, comprising:
providing a source code;
modifying the source code to produce a modified source code; and
verifying the functional equivalence between the source code and the modified source code.

2. The method of claim 1 wherein said verifying comprises comparing type, scope and linkage of identifiers of the source code and the modified source code.

3. The method of claim 1, wherein the verifying the functional equivalence between the source code and the modified source code comprises:
generating assembly codes for the source code and the modified source code;
parsing the assembly codes for obtaining identifiers within the source code and the modified source code;
extracting relationships between the corresponding identifiers in the generated assembly codes, the relationships being extracted on the basis of type, scope and linkage of the identifiers; and
comparing the assembly codes on the basis of the extracted relationships.

4. The method of claim 3, wherein the generating the assembly codes includes identifying the assembly code structure for a computer in which the source codes reside.

5. The method of claim 3, additionally comprising storing identifiers in a hash table.

6. The method of claim 1, wherein the source code and the modified source code reside in different computers.

7. The method of claim 1, wherein the verifying the functional equivalence comprises reporting functional equality if there is a change in offset arising due to difference in the number of unused identifiers associated with the source code and the modified source file.

8. The method of claim 1, wherein the verifying the functional equivalence comprises reporting functional inequality if at least one global symbol is absent in either the source code or the modified source code.

9. The method of claim 1, wherein the verifying the functional equivalence comprises reporting functional inequality if at least one requisite static symbol is absent in either the source code or the modified source code.

10. The method of claim 1, wherein the verifying the functional equivalence comprises reporting functional inequality if at least one requisite static function is absent in either the source code or the modified source code.

11. The method of claim 1, wherein the verifying the functional equivalence comprises reporting functional inequality if at least one macro defined in the source code is redefined in the modified source code.

12. The method of claim 1, additionally comprising reporting reasons for functional inequality between the source code and the modified source code.

13. The method of claim 11 additionally comprising reporting comparison results for functions in the source code that were checked for functional equivalence.

14. The method of claim 11 additionally comprising reporting comparison results in the form of functions that failed a comparison.

15. The method of claim 11 additionally comprising reporting comparison result of a file within the source code, the file being specified by a user.

16. A method for verifying the functional equivalence between a source code and a modified source code in a computer, comprising
identifying the assembly code structure for the computer;
generating assembly codes for the source code and the modified source code based on the assembly code structure for the computer;
parsing the assembly codes for obtaining identifiers in the source code and the modified source code;
extracting relationships between corresponding identifiers in the assembly codes, the relationships being extracted on the basis of type, scope and linkage of the identifiers;
comparing the assembly codes for the functional equivalence on the basis of the extracted relationships; and
reporting the reasons for functional inequality between the source code and the modified source code.

17. A system for verifying functional equivalence between at least two source codes residing in at least one computer, comprising:
at least one CPU templates for identifying the assembly code structure for the computer on which the source codes reside;
a generator for generating an assembly code for each of the source codes based on the identified assembly code structure;
a parser for parsing the assembly codes for each of the source codes for obtaining identifiers in the source codes;
an extractor for extracting relationships between corresponding identifiers in the assembly codes, the relationships being extracted on the basis of type, scope and linkage of the identifiers; and
a comparator for comparing the assembly codes on the basis of the extracted relationships.

18. The system of claim 17, further comprising a reporter for reporting differences between the source codes based on the comparison between the assembly codes.

19. A system for verifying functional equivalence between at least two source codes in a computer, comprising:
a processor;
a machine-readable medium stored in the computer, the machine-readable medium capable of performing the steps of:
modifying a source code to produce a modified source code; and
verifying the functional equivalence between the source code and the modified source code.

20. A machine-readable medium having stored thereon instructions for:
modifying a source code to produce a modified source code; and
verifying the functional equivalence between the source code and the modified source code.

21. A method for verifying functional equivalence of a system comprising:
providing a system;
modifying the system to produce a modified system; and
verifying if the modified system is a functional equivalence of the system.

22. The method of claim 21 wherein said system is selected from a group consisting of a hardware system, a software system, and a mathematical function.

23. A computer assembly for verifying functional equivalence of systems comprising:
means for modifying a system to produce a modified system; and
means for verifying if the modified system is a functional equivalence of the system.
